(19) United States
(12) Patent Application Publication
(10) Pub. No.: US 2006/0032359 A1
(43) Pub. Date: Feb. 16, 2006

(54) Stand for a musical instrument

(76) Inventor: Cole Smith, Kamsack (CA)

Correspondence Address: Mr. Adrian D. Battison;Ade & Company, 1700-360 Main Street, Winnipeg, MB, R3C 3Z3, CA

(21) Appl. No.: 11/198,346

(22) Filed: Aug. 8, 2005

Related U.S. Application Data
(60) Provisional application No. 60/601,114, filed on Aug. 13, 2004.

(51) Int. Cl. G10G 5/00; G10D 3/00

(52) U.S. Cl. 84/327

(57) ABSTRACT

A stand for a musical instrument having a neck includes the case for the instrument which comprises a pair of case half sections hinged along one side edge and closable to form a rectangular housing for receiving the instrument and openable to a partly open angle where a bottom edge of the half sections can rest on a floor surface with the case standing upwardly from the floor surface, such that the hinge is vertical, to a top edge of each half section which is generally horizontal and a plate member which is shaped and arranged to sit on top of the half sections spanning the partly open case, the plate member having a front edge which has a recess therein shaped and arranged to receive the neck of the instrument so as to support the instrument between the sections within the open case above the floor surface.

This application claims the benefit under 35 U.S.C. 119 of the filing date of Provisional Application 60/601,114 filed Aug. 13^{th} 2004.

This invention relates to a stand for a musical instrument of the type having a neck such as a guitar or violin.

### BACKGROUND OF THE INVENTION

The following U.S. patents disclose different arrangements of guitar stand: U.S. Pat. No. 6,462,260 (Fediakov) issued Oct. 8^{th} 2002—U.S. Pat. No. 5,833,051 (Tiefenbrun) issued Nov. 10^{th} 1998; and U.S. Pat. No. 4,223,785 (Jacques) issued Sep. 23^{rd} 1980 all of which use the case as part of the stand arrangement. U.S. Pat. No. 5,346,073 (Broesma) issued Sep. 19^{th} 1994 discloses a plate member which can be fastened to a table top or the like which has a front recess.

### SUMMARY OF THE INVENTION

It is one object of the invention to provide an improved guitar stand.

According to one aspect of the invention there is provided a stand for use with a case for supporting a musical instrument having a neck;

wherein the case comprises a pair of case half sections hinged along one side edge and closable to form a rectangular housing for receiving the instrument and openable to a partly open angle where a bottom edge of the half sections can rest on a floor surface with the case standing upwardly from the floor surface, such that the hinge is vertical, to a top edge of each half section which is generally horizontal;

the stand comprising a plate member which is shaped and arranged to sit on top of the half sections spanning the partly open case;

the plate member having a front edge which has a recess therein shaped and arranged to receive the neck of the instrument so as to support the instrument between the sections within the open case above the floor surface.

Preferably the plate member is shaped on an underside with elements which engage the sections to locate the plate member on the sections and to maintain the sections at the partly open angle.

Preferably the elements are arranged to define shoulders at the angle to engage the sections at the angle.

Preferably the elements extend downwardly from the bottom of the plate member.

Alternatively the elements are defined by a pair of channels in the underside.

Preferably the recess is shaped and arranged such that the neck is located in the recess and a top end of the instrument is held above the plate member so that the instrument is suspended from the plate member.

The arrangement disclosed herein may provide one or more of the following advantages and features:

It is of a simple design, easy to set up, installs in a few seconds;

No parts to lose;

Fits in guitar case when not in use;

Uses the rectangle guitar case as part of the stand to hold and display the guitar on stage or in a music store;

The unique design is attractive;

It can also be used with a bass guitar;

Stabilizers on the underside ensure the case stability if accidentally bumped;

The contoured cutaway recess is designed to hold the guitar by the neck in such a way that the guitar will not fall out when facing forward;

It is unbreakable under normal use. It won't warp, bend, sag, twist or dent;

It will support even the heaviest of guitars;

The guitar case need not be put away when the guitar is on display;

The top of the device offers a flat, even surface which may be used as a support surface to hold or act as a display for picks, strings, keys or the like;

The guitar hangs from the apparatus with no pressure applied to the length of the neck which will reduce the possibility of the neck warping with less tuning problems.

### BRIEF DESCRIPTION OF THE DRAWINGS

One embodiment of the invention will now be described in conjunction with the accompanying drawings in which:

FIG. 1 is an isometric view from the top and front of a stand according to the present invention.

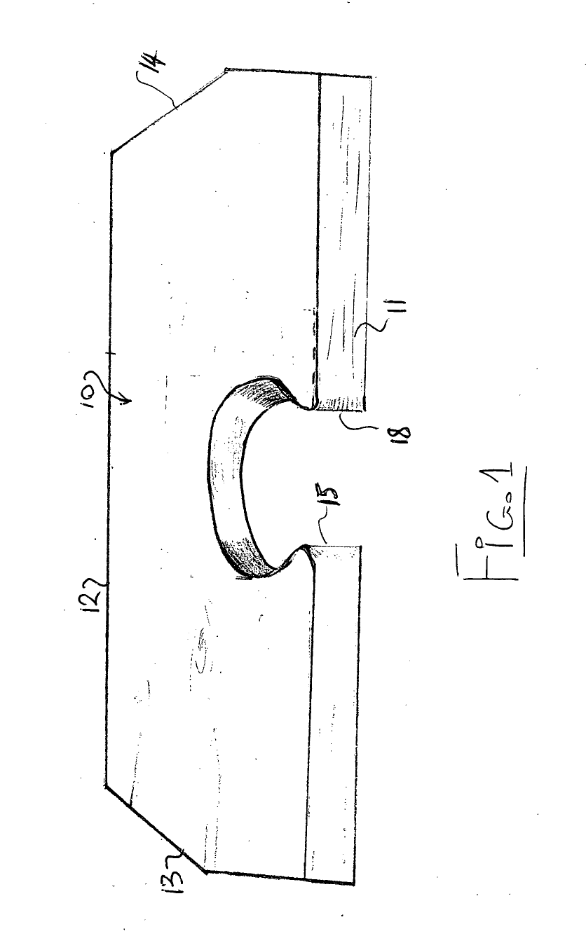

FIG. 2 is an isometric view from the bottom and rear of the stand of FIG. 1.

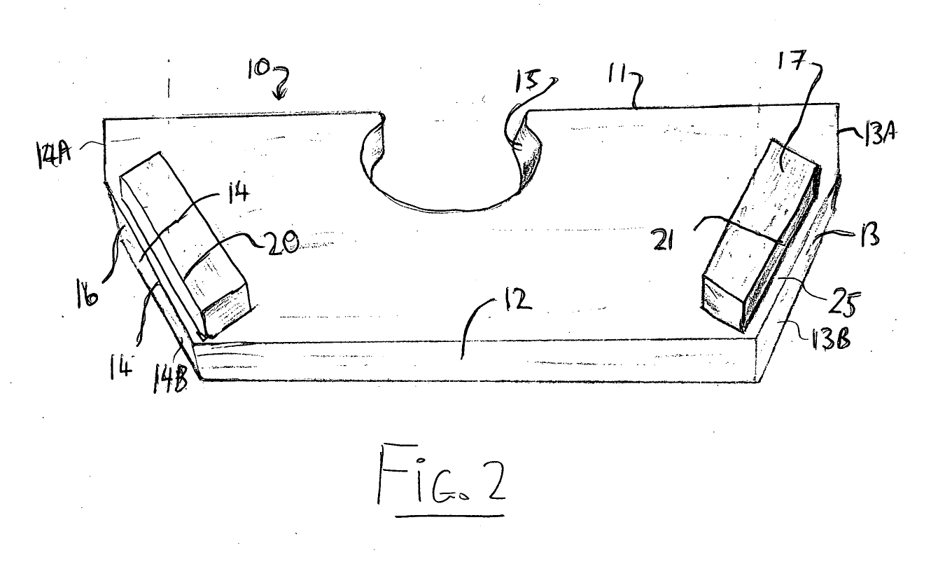

FIG. 3 is an isometric view from the top and front of the stand when in use on a guitar case.

FIG. 4 is bottom plan view of a modified stand in which the shoulders locating the stand on the case are formed as recesses.

In the drawings like characters of reference indicate corresponding parts in the different figures.

### DETAILED DESCRIPTION

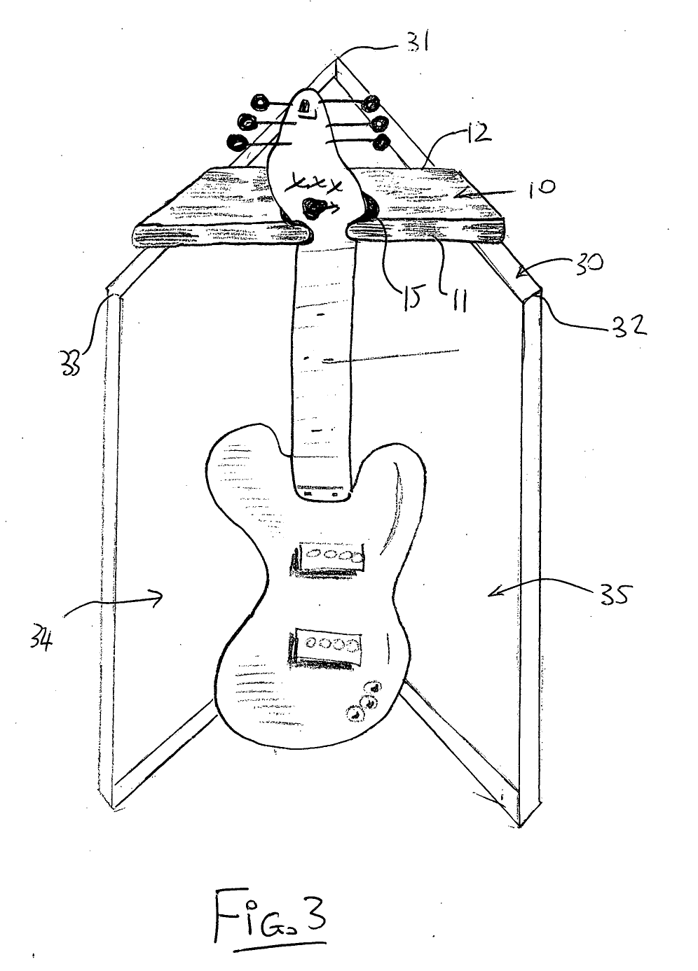

One embodiment of the arrangement is shown in the figures and comprises a plate member 10 which has a front edge 11, a rear edge 12 and two side edges 13 and 14. The plate member is generally flat so it has a flat upper surface and a flat bottom surface, however the specific shaping of plate member is not essential and the only essential elements are the recess 15 at the front edge 11 and the elements 16, 17 on the flat bottom surface which co-operate the open case as shown in FIG. 3. Thus the front edge has an opening 18 defining an entry into the recess 15 which is shaped generally to match the neck of the instrument concerned so the neck can pass through the opening 18 into the recess and can sit conveniently within the recess. However the head at the top end of the instrument cannot pass through the recess and hence when the neck is located in the recess and the head resting on the edges of the recess at the top surface, the instrument is suspended by the plate member 10. The recess converges in front to the neck to prevent the neck from falling forwardly.

On the underside of the plate member is provided the elements 16 and 17 which are shaped at an angle to defined shoulders 20 and 21 of the projecting elements 16 and 17 for engaging suitable surfaces at the opening of the open case 30 as shown in FIG. 3. Thus a portion of the plate member as indicated at 24, 25 is exposed beyond the shoulders 20 and 12 respectively to sit on top of the case. The angle of the shoulders 20 and 21 converges to an imaginary point at the rear of the structure which will be approximately coincident with the hinge 31 of the case so as to locate the plate member on the open case at a position spaced forwardly form the hinge thus supporting the recess within the open case forwardly of the hinge and rearwardly of the front open edges 32, 33 of the case.

Thus the case stands upwardly from the floor surface with the hinge vertical and the two half sections 34, 35 pivoted partly open to an angle of the order of ninety degrees. Thus, if the angle is selected to be ninety degrees, the shoulders 20, 21 are arranged at the same angle so that they hold the case at this required angle. The angle can of course vary depending upon the size of the case and the size of the instrument.

The rear edge 12 is parallel to the front edge and is spaced well forward of the hinge line. The side edges 13 and 14 include a first portion 13A, 14A which is at right angles to the front and rear edges and the second portion 13B, 14B which converges at the angle as the angle of the partly open case.

In alternative arrangements, the plate member may be formed as an integral construction with the case itself so that it is attached to one half section of the case by a pivot arrangement which allows it to be pivoted upwardly from the interior of the half section to the position at right angles to the half sections and arranged to clip over the opposite half section at the required angle. Thus the device may be permanently attached at one side by hinge line and attached at the other side when required by some form of clip which engages over the edge.

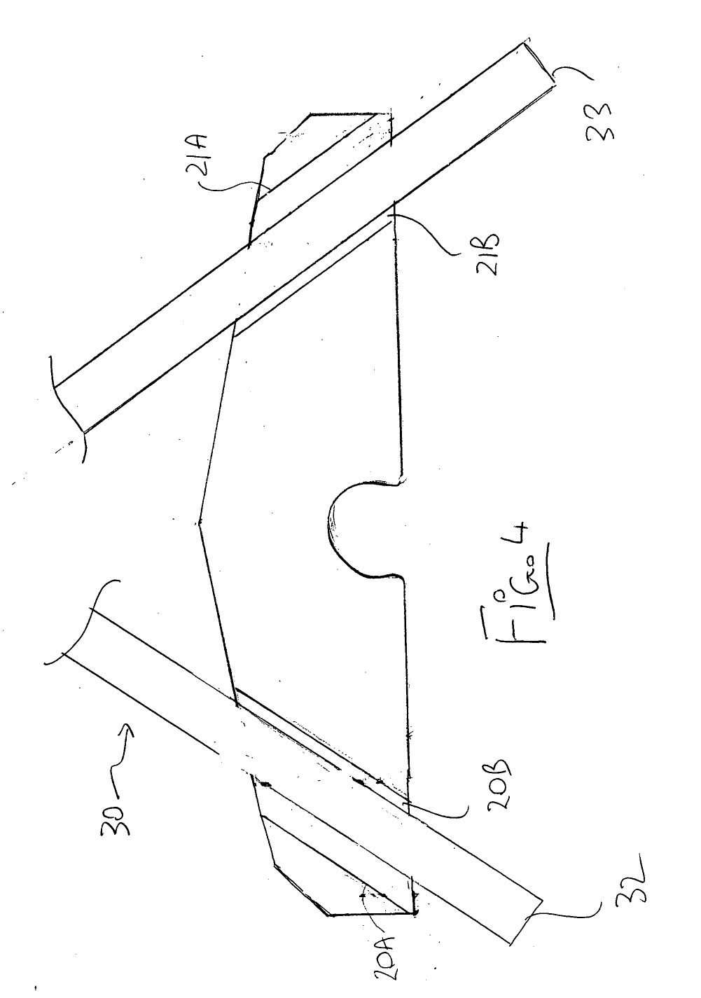

The arrangement as shown is formed from a flat plate member with the elements 16 and 17 attached thereto to extend downwardly there from. However the shoulders 20A, 21A can be formed by recesses 20B, 21B cut into the thickness in the plate member as shown in FIG. 4. Alternatively the plate member can be molded or shaped rather than formed from individual flat pieces.

The recess may be edged in felt or foam to ensure less friction against guitar neck.

The entire apparatus may be covered in a durable covering fabric material such as denim, vinyl or tolex.

The top of apparatus can be adapted to hold drinks by using non-slip covering or providing circular cutaway to hold cups.

The apparatus may be made larger or in different shape to provide more surface area to hold more items.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A stand for use with a case for supporting a musical instrument having a neck;
wherein the case comprises a pair of case half sections hinged along one side edge and closable to form a rectangular housing for receiving the instrument and openable to a partly open angle where a bottom edge of the half sections can rest on a floor surface with the case standing upwardly from the floor surface, such that the hinge is vertical, to a top edge of each half section which is generally horizontal;
the stand comprising a plate member which is shaped and arranged to sit on top of the half sections spanning the partly open case;
the plate member having a front edge which has a recess therein shaped and arranged to receive the neck of the instrument so as to support the instrument between the sections within the open case above the floor surface.

2. The stand according to claim 1 wherein the plate member is shaped on an underside with elements which engage the sections to locate the plate member on the sections and to maintain the sections at the partly open angle.

3. The stand according to claim 1 wherein the elements are arranged to define shoulders at the angle to engage the sections at the angle.

4. The stand according to claim 1 wherein the elements extend downwardly from the bottom of the plate member.

5. The stand according to claim 1 wherein the recess is shaped and arranged such that the neck is located in the recess and the top end is held above the plate member so that the instrument is suspended from the plate member.

6. The stand according to claim 1 wherein the elements are formed by the side edges of recesses in the bottom of the plate member.

7. A stand for a musical instrument having a neck comprising:
a case for the instrument which comprises a pair of case half sections hinged along one side edge and closable to form a rectangular housing for receiving the instrument and openable to a partly open angle where a bottom edge of the half sections can rest on a floor surface with the case standing upwardly from the floor surface, such that the hinge is vertical, to a top edge of each half section which is generally horizontal;
and a plate member which is shaped and arranged to sit on top of the half sections spanning the partly open case;
the plate member having a front edge which has a recess therein shaped and arranged to receive the neck of the instrument so as to support the instrument between the sections within the open case above the floor surface.

8. The stand according to claim 7 wherein the plate member is shaped on an underside with elements which engage the sections to locate the plate member on the sections and to maintain the sections at the partly open angle.

9. The stand according to claim 7 wherein the elements are arranged to define shoulders at the angle to engage the sections at the angle.

10. The stand according to claim 7 wherein the elements extend downwardly from the bottom of the plate member.

11. The stand according to claim 7 wherein the recess is shaped and arranged such that the neck is located in the recess and the top end is held above the plate member so that the instrument is suspended from the plate member.

12. The stand according to claim 7 wherein the elements are formed by the side edges of recesses in the bottom of the plate member.
